(19) United States
(12) Patent Application Publication
(10) Pub. No.: US 2020/0079163 A1
(43) Pub. Date: Mar. 12, 2020

(54) Temporary Support for All-Terrain Vehicle

(71) Applicant: Jasper Built Properties, LLC, Midland, GA (US)

(72) Inventor: Jasper R. Woodham, IV, Midland, GA (US)

(21) Appl. No.: 16/568,472

(22) Filed: Sep. 12, 2019

Related U.S. Application Data
(60) Provisional application No. 62/730,087, filed on Sep. 12, 2018.

(51) Int. Cl. B60D 1/155; B60D 1/14; B60D 1/66

(52) U.S. Cl. CPC B60D 1/155; B60P 3/125; B60D 1/665; B60D 1/143

(57) ABSTRACT

A vehicle support for an all-terrain vehicle allows an all-terrain vehicle with a broken wheel, axle, or suspension to be either driven or towed. The vehicle support has a telescoping support beam with an outer end, a center section, and a cross beam at its inner end. The center section of the telescoping beam is positioned under and contacts a horizontal member of the frame of the all-terrain vehicle and the cross beam is strapped to other horizontal members of the frame. The outer end of the telescoping beam is equipped with either an auxiliary wheel hub, a caster wheel, a tow hook, or a trailer hitch. The auxiliary wheel hub and the caster wheel allow the all-terrain vehicle to be driven, and the tow hook and the trailer hitch allow the all-terrain vehicle to be towed.

### CLAIM OF PRIORITY

This application claims priority from U.S. Provisional Patent Application Ser. No. 62/730,087, filed on Sep. 12, 2018, which is incorporated herein in its entirety.

### FIELD OF THE INVENTION

This invention relates to all-terrain vehicles and more specifically to a temporary support for temporarily replacing a broken wheel, axle, or suspension of an all-terrain vehicle so that the all-terrain vehicle can be driven or towed.

### BACKGROUND OF THE INVENTION

All-terrain recreational vehicles are often subjected to rugged trail conditions. Such rugged trail conditions may in some cases cause the wheel, axle, or suspension to fail. Once a wheel, an axle, or a suspension fails, the all-terrain vehicle can no longer be driven. Such failures of a wheel, an axle, or a suspension often occur in remote areas where repairs cannot be made. Further, access to the remote area by a vehicle with a trailer to retrieve the disabled all-terrain vehicle may be difficult or impossible. Consequently, there is a need for a temporary repair that will allow the disabled all-terrain vehicle to be driven or towed to a location for repair.

### SUMMARY OF THE INVENTION

In order to overcome the problem presented by a failed wheel, axle, or suspension of an all-terrain vehicle, a temporary vehicle support is provided to temporarily replace the failed wheel, axle, or suspension. The temporary vehicle support for the all-terrain vehicle is lightweight and portable and allows for recovery of damaged the all-terrain vehicle or other off-road equipment. The temporary vehicle support is designed to be carried by the all-terrain vehicle or equipment and to be deployed as needed for various circumstances where a wheel, an axle, or a suspension system has failed. The temporary vehicle support allows a damaged all-terrain vehicle to operate under its own power and control during transit before permanent repairs are made. The temporary vehicle support may also be used to tow the damaged all-terrain vehicle. The temporary vehicle support is universally adapted to many different makes, models, and types of damaged vehicles and equipment. The temporary vehicle support is designed for temporary use but is able to sustain substantial abuse while in use. The temporary vehicle support has multiple configurations in order to adapt to many damaged vehicles and situations.

The temporary vehicle support is comprised of various lengths and sizes of steel and/or aluminum tubing or channel members with multiple attachment points of the all-terrain vehicle. The temporary vehicle support is secured to a damaged vehicle or equipment using standard chains, cables, and strapping as necessary. Make and model specific brackets may also be used for securing the temporary vehicle support as necessary. The temporary vehicle support is designed to collapse and fold upon itself to limit storage space required during non-use. The temporary vehicle support is adjustable through the use various holes and brackets that provide for varying heights, lengths, and widths. Various wheels and hubs can be fitted to the temporary vehicle support to allow use with many makes and models of all-terrain vehicles.

Further objects, features and advantages will become apparent upon consideration of the following detailed description of the invention when taken in conjunction with the drawings and the appended claims.

### Q BRIEF DESCRIPTION OF THE DRAWINGS

FIG. 1 is a side perspective view of a frame of an all-terrain vehicle that illustrates the environment of the present invention.

FIG. 2 is a front perspective view of a first embodiment of a temporary vehicle support for an all-terrain vehicle in accordance with the present invention.

FIG. 3 is an enlarged side elevation view of the first embodiment of the temporary vehicle support for an all-terrain vehicle in accordance with the present invention.

FIG. 4 is a perspective detail view of the first embodiment of the temporary vehicle support for an all-terrain vehicle in accordance with the present invention.

FIG. 5 is a back perspective view of a second embodiment of a temporary vehicle support for an all-terrain vehicle in accordance with the present invention.

FIG. 6 is an enlarged side elevation view of a third embodiment of the temporary vehicle support for an all-terrain vehicle in accordance with the present invention.

FIG. 7 is a partial front perspective view of a fourth embodiment of the temporary vehicle support for an all-terrain vehicle in accordance with the present invention.

FIG. 8 is a partial front perspective view of a fifth embodiment of the temporary vehicle support for an all-terrain vehicle in accordance with the present invention.

FIG. 9 is a partial front perspective view of a sixth embodiment of the temporary vehicle support for an all-terrain vehicle in accordance with the present invention.

FIG. 10 is a partial front perspective view of a seventh embodiment of the temporary vehicle support for an all-terrain vehicle in accordance with the present invention.

### DETAILED DESCRIPTION OF THE PREFERRED EMBODIMENTS

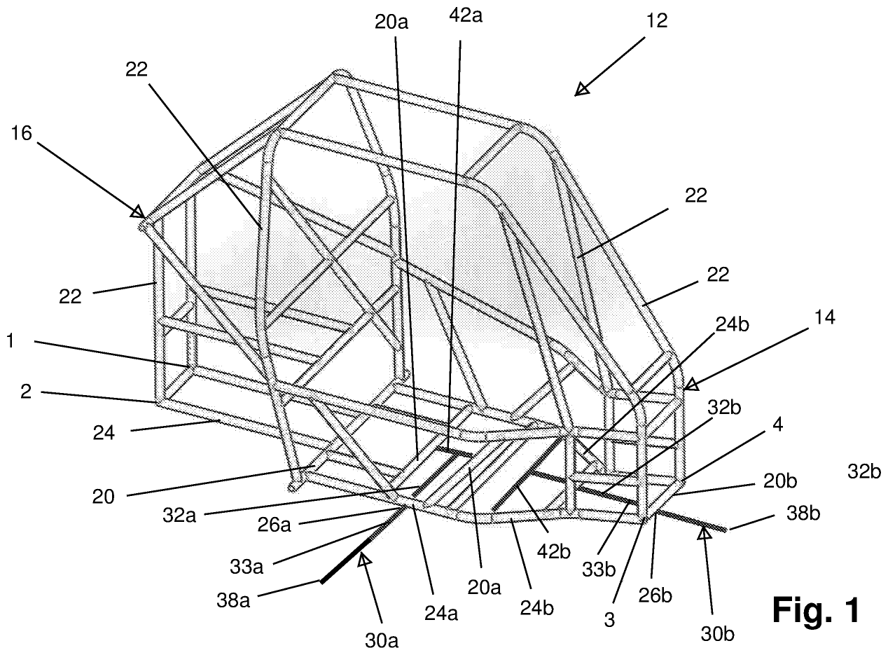

FIG. 1 illustrates a generic frame 12 of a four wheel all-terrain vehicle with wheels (not shown) and suspension systems (not shown) at the four corners 1, 2, 3, 4 of the frame 12. The frame 12 has a front 14 and a rear 16. In addition, the frame 12 has a plurality of structural frame members including horizontal cross frame members 20, horizontal longitudinal frame members 24, and various vertical frame members 22.

If one of the wheels, axles, or suspension systems fail during use of the all-terrain vehicle, the user needs a way of driving or towing the disabled all-terrain vehicle to a place where permanent repairs can be made. For the following description of the present invention, the all-terrain vehicle frame 12 is assumed to have a wheel, an axle, or a suspension failure at the front corner 3 with the wheels, axles, and suspension systems at the other four corners 1, 2, 4 remaining intact and operational.

FIG. 1 further illustrates two ways in which the vehicle support 30 of the present invention provides temporary support so that the all-terrain vehicle can be driven or towed to a place for permanent repairs. The vehicle support 30a illustrates schematically the use of the vehicle support in a cross frame configuration, and the vehicle support 30b illustrates schematically the use of the vehicle support in a longitudinal frame configuration.

For the cross frame configuration, the vehicle support 30a uses an auxiliary hub 72 (FIG. 8) or an auxiliary caster wheel 76 (FIG. 9). Both cross frame configurations 30a allow the all-terrain vehicle to be driven as long as the drive wheels at the rear 16 of the all-terrain vehicle remain operational.

For longitudinal frame configuration, the vehicle support 30b uses a tow hook 68 (FIG. 7) or a trailer hitch 88 (FIG. 10). Both longitudinal frame configurations 30b allow the all-terrain vehicle to be supported and towed behind another vehicle.

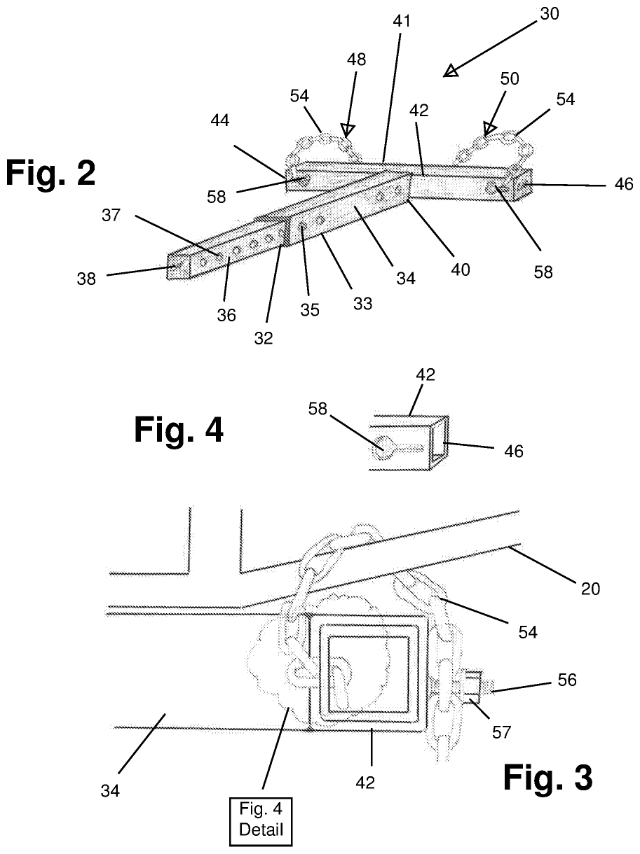

Turning to FIG. 2, the vehicle support 30 includes a telescoping beam 32 having an external channel member 34 and an internal channel member 36. The telescoping beam 32 has an outer end 38, an inner end 40, and a center section 33. The external channel member 34 and the internal channel member 36 have external channel holes 35 and internal channel holes 37 respectively. Pins or bolts (not shown) are inserted through the external channel holes 35 and the internal channel holes 37 to lock the external channel member 34 and the internal channel member 36 together in order to establish the length of the telescoping beam 32. The length of the telescoping beam 32 is set to match the dimensions of the horizontal members 20 and 24 of the all-terrain vehicle frame 12.

A frame connector 41 is attached to the inner end 40 of the beam 32. The frame connector 41 comprises a cross beam 42 having a left end 44 and a right end 46. In order to connect the vehicle support 30 to the underside of a horizontal cross member 20 or a horizontal longitudinal member 24 of the all-terrain vehicle frame 12, the cross beam 42 has a left end cross beam connector 48 and a right end cross beam connector 50. In the embodiment shown in FIG. 2, the left end cross beam connector 48 and the right end cross beam connector 50 comprise a link chain 54 that attaches to the left end 44 and the right end 46 by means of a keyhole 58 and a stud 58 and nut 57. The chain 54 is inserted into the keyhole 58 and secured, wrapped around the horizontal cross frame member 20 and secured by the stud 56 and nut 57 as shown in FIG. 3. By the varying length of the chain between the keyhole 58 and the stud 56, the connection between the cross beam 42 and the horizontal cross frame member 20 can be adjusted to accommodate different positioning of the various horizontal cross frame members 20 of the frame 12 of the all-terrain vehicle.

With reference to FIG. 1, the center section 33a of vehicle support 30a passes under horizontal longitudinal frame member 24a and contacts the frame 12 at support point 26a. The cross beam 42a is connected to horizontal cross members 20a, such as by use of the link chain 54 as described above. Upward force on the end 38a of the vehicle support 30a transmits that force to support point 26a and thereby supports the all-terrain vehicle at the corner 3 where the wheel, axle, or suspension has failed.

Likewise, the center section 33b of the vehicle support 30b passes under horizontal cross frame member 20b and contacts the frame 12 at support point 26b. The cross beam 42b is connected to horizontal longitudinal members 24b, such as by use of the link chain 54 as described above. Upward force on the end 38a of the vehicle support 30a transmits that force to support point 26b and thereby supports the all-terrain vehicle at the corner 3 where the wheel or suspension has failed.

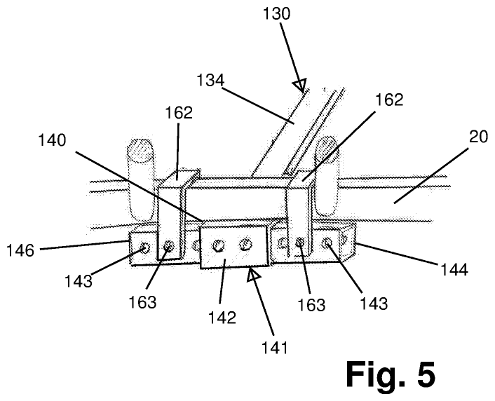

FIG. 5 illustrates a second embodiment of a frame connector 141 for a vehicle support 130. For the vehicle support 130 shown in FIG. 5, the chain 54 for the vehicle support 30 shown in FIGS. 2 and 3 is replaced by U bolts or U straps 162. The vehicle support 130 has an external channel 134 with a cross beam 142 attached to its inner end 140. The cross beam 142 has a left end 144 and a right end 146. The cross beam 142 also has a series of holes 143 extending along its length. The U straps 162 have matching holes 163. In order to install the vehicle support 130, the U straps 162 extend over the horizontal cross frame member 20 and are connected by bolts (not shown) through the U strap holes 163 and the cross beam holes 143.

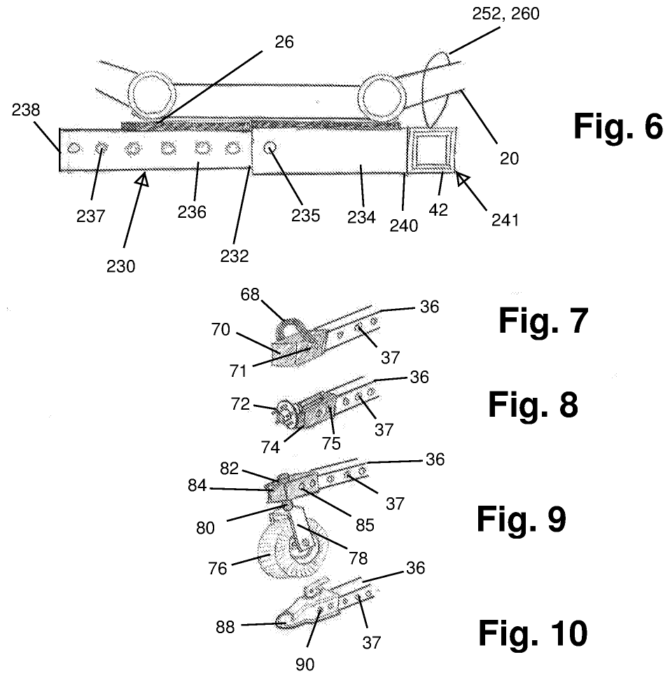

FIG. 6 illustrates a third embodiment of a vehicle support 230. The vehicle support 230 includes a telescoping beam 232 having an external channel member 234 and an internal channel member 236. The telescoping beam 232 has an outer end 238, an inner end 240, and a center section 233. The external channel member 234 and the internal channel member 236 have external channel holes 235 and internal channel holes 237 respectively. Pins or bolts (not shown) are inserted through the external channel holes 235 and the internal channel holes 237 to lock the external channel member 234 and the internal channel member 236 together in order to establish the length of the telescoping beam 232.

A frame connector 241 is attached to the inner end 240 of the telescoping beam 232. The frame connector 241 comprises a cross beam 242. In order to connect the vehicle support 230 to the underside of a horizontal cross member 20 or a horizontal longitudinal member 24 of the all-terrain vehicle frame 12, the cross beam 242 has an adjustable cargo straps 260 or adjustable wire cable 252 attached to each end of the cross beam 242. By the varying length of the cargo strap 260 or the wire cable 252, the connection between the cross beam 242 and the horizontal cross frame member 20 can accommodate different positioning of the various horizontal cross frame members 20 of the frame 12 of the all-terrain vehicle.

FIGS. 7-10 show various configurations for the outer end 38 of the vehicle support 30. Each configuration has the common characteristic of supporting the outer end 38 of the vehicle support 30 thereby lifting the all-terrain vehicle for transportation in the event of a failure of the wheel, axle, or suspension at corner 3 shown in FIG. 1.

FIG. 7 illustrates a tow hook 68 attached to a tow hook connector sleeve 70 with tow hook connector holes 71. The tow hook connector sleeve 70 slides over the end 38 of internal channel member 36 and is locked in place by bolts inserted through tow hook connector holes 71 and internal channel holes 37. The illustrated tow hook 68 is adapted for use in connection with the vehicle support 30b shown in FIG. 1. With the vehicle support 30b in place as shown in FIG. 1, of vehicle can be attached to the tow hook 68 to raise the frame 12 and pull the disabled all-terrain vehicle in the forward direction.

Similarly, FIG. 10 illustrates a trailer hitch 88 with trailer hitch holes 90 that aligned with internal channel holes 37 so that the trailer hitch 88 can be bolted to the outer end 38 of the vehicle support 30. Again, the configuration shown in FIG. 10 is adapted to be positioned as vehicle support 30b shown in FIG. 1 so that a vehicle can be connected to the trailer hitch 88 and thereby tow the disabled all-terrain vehicle.

FIG. 8 illustrates an auxiliary hub 72 attached to a hub connector sleeve 74 with hub connector holes 75. The hub connector sleeve 74 slides over the end 38 of internal channel member 36 and is locked in place by bolts inserted through hub connector holes 75 and internal channel holes 37. The illustrated auxiliary hub 72 is adapted for use in connection with the vehicle support 30a shown in FIG. 1. With the vehicle support 30a in place as shown in FIG. 1 and with the hub 72 and wheel attached to the outer end 38a of the vehicle support 30a, the all-terrain vehicle can be driven as long as the rear drive wheels of the all-terrain vehicle are operational.

FIG. 9 illustrates a caster wheel 76 with a caster wheel fork 78 and a caster wheel stem 80. The caster wheel stem 80 is rotatably mounted to a caster wheel sleeve 84 with a bearing 82 to accommodate the caster wheel stem 80. The caster wheel sleeve 84 has holes 85. The caster wheel sleeve 84 slides over the outer end 38 of the internal channel member 36 and is locked in place by bolts inserted through sleeve holes 85 and internal channel holes 37. The illustrated caster wheel 76 is adapted for use in connection with the vehicle support 30a shown in FIG. 1. With the vehicle support 30a in place as shown in FIG. 1 and with the caster wheel 76 attached to the outer end 38a of the vehicle support 30a, the all-terrain vehicle can be driven as long as the rear drive wheels of the all-terrain vehicle are operational

While this invention has been described with reference to preferred embodiments thereof, it is to be understood that variations and modifications can be affected within the spirit and scope of the invention as described herein and as described in the appended claims.

I claim:

1. A vehicle support for an all-terrain vehicle with a failed wheel, axle, or suspension and having a frame with at least two spaced apart horizontal members, the temporary support comprising:
a. a first beam having a length and including:
i. an outer end;
ii. an inner end; and
iii. a center section;
b. an outer end carrier attached to the outer end of the beam; and
c. a frame connector attached to the inner end of the first beam for connecting the inner end of the first beam to at least one horizontal member of the all-terrain vehicle.

2. The vehicle support of claim 1, wherein the first beam includes an external channel member and an internal channel member, wherein the internal channel member telescopes into the external channel member, and wherein the length of the beam is adjusted by relative positioning of the internal channel member within the external channel member.

3. The vehicle support of claim 1, wherein the frame connector comprises a link chain secured adjacent the inner end of the first beam.

4. The vehicle support of claim 1, wherein the frame connector comprises a U strap secured adjacent the inner end of the first beam.

5. The vehicle support of claim 1, wherein the frame connector comprises an adjustable length wire cable secured adjacent the inner end of the first beam.

6. The vehicle support of claim 1, wherein the frame connector comprises an adjustable length cargo strap secured adjacent the inner end of the first beam.

7. The vehicle support of claim 1, wherein the frame connector includes a cross beam attached to the inner end of the first beam and having a cross beam connector at each end for connecting the cross beam to at least one horizontal member of the frame.

8. The vehicle support of claim 1, wherein the outer end includes a tow hook.

9. The vehicle support of claim 1, wherein the outer end includes a trailer hitch.

10. The vehicle support of claim 1, wherein the outer end includes a wheel hub.

11. The vehicle support of claim 1, wherein the outer end includes a caster wheel.

12. A method for temporarily supporting for transport an all-terrain vehicle with a broken wheel, axle, or suspension and having a frame with at least two spaced apart horizontal members, the method comprising the steps of:
a. attaching a vehicle support to an all-terrain vehicle with a broken wheel, axle, or suspension, wherein the vehicle support includes
i. a first beam including:
(a) an outer end;
(b) an inner end; and
(c) a center section;
b. attaching an outer end carrier to the outer end of the beam;
c. attaching the inner end of the first beam to at least one horizontal member of the frame of the all-terrain vehicle; and
d. resting another horizontal frame member of the frame of the all-terrain vehicle on the center section of the vehicle support.
